(19) United States
(12) Patent Application Publication
(10) Pub. No.: US 2019/0333149 A1
(43) Pub. Date: Oct. 31, 2019

(54) System and Method of Managing a Cryptocurrency-Based Portfolio

(71) Applicant: Donnie Kim, Richmond Hill (CA)

(72) Inventor: Donnie Kim, Richmond Hill (CA)

(21) Appl. No.: 16/398,039

(22) Filed: Apr. 29, 2019

Related U.S. Application Data
(60) Provisional application No. 62/663,941, filed on Apr. 27, 2018.

(51) Int. Cl. G06Q 40/04; G06Q 20/36; G06Q 20/38; G06Q 20/06

(52) U.S. Cl. CPC G06Q 40/04; G06Q 20/3678; G06Q 2220/00; G06Q 20/0658; G06Q 20/389

(57) ABSTRACT

A system and method of managing a cryptocurrency-based portfolio that facilitates the creation and/or redemption of exchange trade fund (ETF) tokens is provided. Additionally, the system and method allows a user to store multiple types of digital currencies on a single platform. A user is able to initiate a creation transaction that allows the user to exchange multiple types of digital currencies for ETF tokens. Similarly, a user is able to initiate a redemption transaction that allows the user to exchange ETF tokens for multiple types of digital currencies. The processed creation and/or redemption transactions are recorded and verified with a blockchain ledger which prevents any medication to the transactions. The ETF tokens include an exchange value which is continuously monitored and varies based on the market values of the multiple types of digital currencies. The user is able to trade and/or exchange the ETF tokens after the creation transaction.

The current application claims a priority to the U.S. Provisional Patent application Ser. No. 62/663,941 filed on Apr. 27, 2018. The current application is filed on Apr. 29, 2019 while Apr. 27, 2019 was on a weekend.

### FIELD OF THE INVENTION

The present invention relates generally to the field of data processing. More specifically, the present disclosure describes methods and systems to facilitate the creation and/or redemption of exchange trade fund (ETF) tokens representing a portfolio of multiple cryptocurrencies.

### BACKGROUND OF THE INVENTION

Recent years have witnessed tremendous interest in cryptocurrencies due to their decentralized control and the security offered by the underlying blockchain technology. Accordingly, several cryptocurrencies have been introduced and an ecosystem based on cryptocurrencies has been steadily growing. Further, several exchanges are available that facilitate buying, selling and/or trading of cryptocurrencies.

Additionally, with the increasing acceptance of cryptocurrencies by markets, financial instruments are evolving to accommodate cryptocurrencies. For example, there is an interest towards forming security assets based on cryptocurrencies. However, existing technologies for supporting trading of traditional security assets are not capable of facilitating trading of security assets based on cryptocurrencies. Therefore, there is a need for improved methods and systems to facilitate provisioning of security assets such as, for example, an Exchange Traded Fund (ETF) based on cryptocurrencies. In particular, there is a need for methods and systems that facilitate creation and/or redemption of ETF tokens representing a portfolio of multiple cryptocurrencies.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter scope.

Disclosed herein are methods and systems for facilitating management of security assets comprising a plurality of cryptocurrencies. In particular, a method and a system for facilitating creation and/or redemption of an Exchange Traded Fund (ETF) based on cryptocurrencies are provided.

The system may include a communication device configured to communicate with one or more user devices (such as desktop computers, laptop computers, mobile devices etc.) over a communication network such as, but not limited to, the Internet. Further, the system may include a processing device configured to carry out one or more processing steps in order to facilitate creation and/or redemption of the ETF based on cryptocurrencies. Further, the system may include a storage device configured to store data in order to facilitate creation and/or redemption of the ETF based on cryptocurrencies. Additionally, the storage device may be configured to perform one or more storage and/or access operations based on blockchain technology and/or a distributed ledger.

According to some embodiments, the method of facilitating creation and/or redemption of the ETF based on cryptocurrencies may include a step of, receiving, using the communication device, a creation request from a user device. For instance, the user device, such as a computing device, may be associated with an Authorized Participant (AP) and/or an Issuer of the ETF. Further, the creation request may include indication of a plurality of cryptocurrencies and a corresponding plurality of quantities associated with the plurality of cryptocurrencies. Further, the creation request may also include a number of shares (or ETF tokens). A combination of the plurality of cryptocurrencies according to the plurality of quantities may constitute a basket. Further, the basket may be partitioned into the number of shares resulting in a one or more ETF tokens which may be subsequently traded.

Further, the creation request may also include indication of a plurality of wallets associated with the plurality of cryptocurrencies. Further, in some embodiments, the creation request may also include indication of a plurality of addresses (i.e. addresses in relation to a storage device hosting the plurality of wallets) corresponding to the plurality of cryptocurrencies.

Accordingly, the method may include, a step of verifying whether each wallet of the plurality of wallets includes an amount of cryptocurrency sufficient to satisfy the creation request. In particular, the method may include verifying whether the plurality of quantities specified in the creation request is satisfied by a plurality of amounts of cryptocurrencies currently available in the plurality of wallets.

Further, the method may include a step of transferring the plurality of cryptocurrencies from the plurality of wallets into a present invention. In some embodiments, the step of transferring may be carried out simultaneously. In other words, each cryptocurrency of corresponding quantity from each wallet may be transferred into the present invention at the same time instant and/or time period. Further, in some embodiments, the step of transferring may be based on the step of verifying. In other words, the transferring may take place only upon successful verification of sufficient amounts of cryptocurrencies being available in the plurality of wallets.

Further, the method may include a step of transferring, according to a blockchain based smart-contract, a one or more ETF tokens in exchange for the plurality of cryptocurrencies of the plurality of quantities. In some embodiments, the method may include minting the one or more ETF tokens. Alternatively, and/or additionally, the one or more ETF tokens may be obtained from a pre-existing pool of ETF tokens.

Further, the method may include a step of receiving, using the communication device, a redemption request from a user device. Further, the method may include a step of determining, using the processing device, whether the present invention includes one or more amounts of cryptocurrencies sufficient to satisfy the redemption request. In particular, the method may include verifying whether the plurality of amounts of cryptocurrencies corresponding to one or more ETF tokens associated with the redemption request is currently available in the present invention. Accordingly, based on the redemption request, the one or more ETF tokens may be redeemed to obtain the plurality of cryptocurrencies. Accordingly, upon fulfilling the redemption request, the plurality of cryptocurrencies is transferred from the present invention to the corresponding plurality of wallets. Further, subsequent to redemption, the one or more ETF tokens are returned to the pre-existing pool of ETF tokens. Alternatively and/or additionally, the one or more ETF tokens may be destroyed according to the blockchain based smart-contract.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

FIG. 1 is a diagram illustrating the system of the present invention.

FIG. 2A is a flowchart illustrating the overall method of the present invention.

FIG. 2B is a flowchart continuation illustrating the overall method of the present invention.

FIG. 3 is a flowchart illustrating the subprocess of calculating the exchange value.

FIG. 4 is a flowchart illustrating the subprocess of determining the specific token quantity.

FIG. 5 is a flowchart illustrating the subprocess of determining if the user has sufficient funds in order to receive the ETF tokens.

FIG. 6 is a flowchart illustrating the subprocess of the creation transaction.

FIG. 7 is a flowchart illustrating an alternative subprocess of the creation transaction.

FIG. 8 is a flowchart illustrating the subprocess of the redemption transaction.

FIG. 9 is a flowchart illustrating an alternative subprocess of the redemption transaction.

FIG. 10 is a flowchart illustrating the subprocess of trading or exchanging ETF tokens on a digital currency exchange platform.

FIG. 11 is a flowchart illustrating the subprocess of scheduling a future creation transaction.

FIG. 12 is a flowchart illustrating the subprocess of scheduling a future redemption transaction.

FIG. 13 is an illustration of an exemplary embodiment of the online platform.

FIG. 14A shows an exemplary architecture of a system to facilitate the creation and/or redemption of one or more ETF tokens illustrating how coins are stored, how transactions are synced and scheduled on the database, how the blockchain nodes are integrated with the present invention, how the present invention communicates with the Authorized Participants through a Central Authentication Server, how the Authorized Participants function as Trading desks that are integrated with different crypto exchanges and how the retail client interfaces are related to the Trading Desk, in accordance with some embodiments.

FIG. 14B is a continuation of FIG. 14A.

FIG. 15 shows a process to facilitate the ‘creation’ of ETF tokens representing a portfolio of multiple cryptocurrencies, in accordance with some embodiments.

FIG. 16 shows a process to facilitate the ‘redemption’ of ETF tokens representing a portfolio of multiple cryptocurrencies, in accordance with some embodiments.

FIG. 17A shows an exemplary flowchart displaying the processes of creation and/or redemption of one or more ETF tokens, in accordance with some embodiments.

FIG. 17B is a continuation of FIG. 17A.

FIG. 17C is a continuation of FIG. 17A.

FIG. 18 is a block diagram of a computing device for implementing the methods disclosed herein, in accordance with some embodiments.

### DETAIL DESCRIPTIONS OF THE INVENTION

All illustrations of the drawings are for the purpose of describing selected versions of the present invention and are not intended to limit the scope of the present invention.

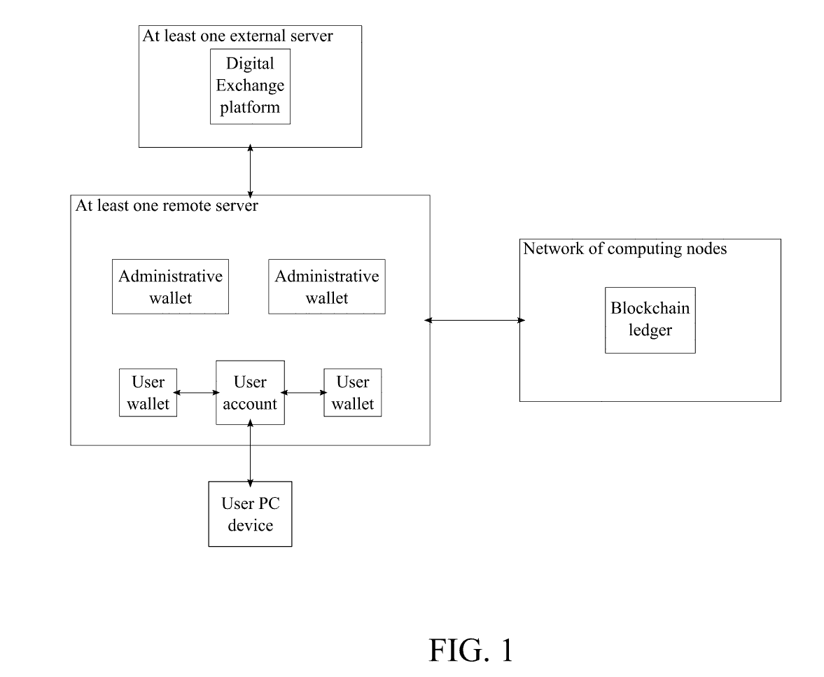

In reference to FIGS. 1 through 12, the present invention is a system and method for managing a cryptocurrency-based portfolio that facilitates a creation and/or redemption of exchange trade fund (ETF) tokens. Additionally, the present invention allows a user to store multiple types of digital currencies on a single platform. With reference to FIG. 1, the system of the present invention includes at least one remote server and a network of computing nodes. The remote server is a centralized server used to manage the administrative processes of the present invention. Moreover, the remote server is able to manage a plurality of cryptocurrency types and at least one ETF token type (Step A). The plurality of cryptocurrency types is a set of different digital currencies such as, but not limited to, Bitcoin, Litecoin, or Ethereum. The ETF token type is a digital token that is designed to track a particular stock index or bond index. Essentially, the ETF token type functions as an exchange trade fund. Furthermore, the remote server is used to manage at least one user account (Step B). The user account allows a user, that is given permission, to interact with and/or use the features offered by the present invention. The user account is associated with a user personal computing (PC) device. The PC device may be any type of computing device such as, but not limited to, a desktop computer, a laptop computer, a mobile device, a smartphone, or an electronic tablet. In order to store multiple types of digital currencies, the user account includes a plurality of user wallets. The plurality of user wallets allows the user to store different types of digital currency through the present invention. Each cryptocurrency type or ETF token type is associated to a corresponding wallet from the plurality of user wallets in order for the user to store different types of digital currencies. Additionally, the remote server is used to manage a plurality of administrative wallets (Step C). The plurality of administrative wallets is used to store different types of digital currency which is transferred from or to the corresponding user wallet. The network of computing nodes is used to manage a blockchain ledger (Step D). The blockchain ledger is a distributed ledger which is used to record and verify transactions processed through the present invention.

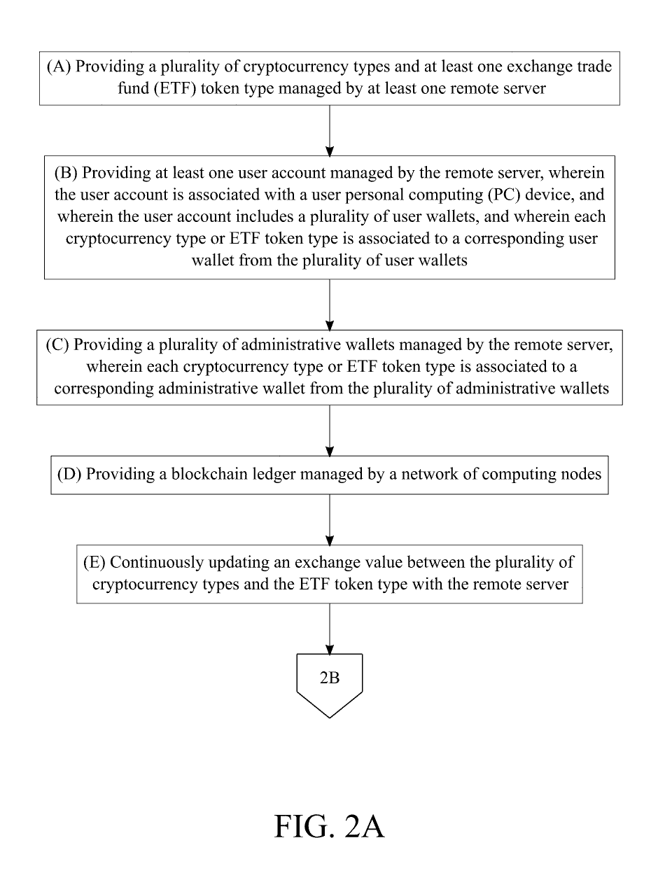

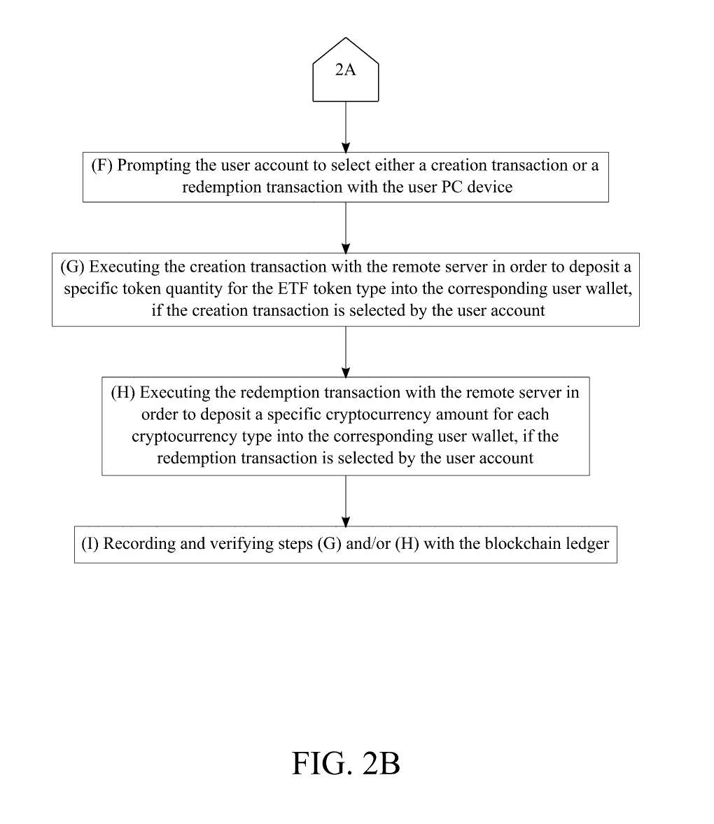

With reference to FIGS. 2A and 2B, the method of the present invention follows an overall process that facilitates the creation and/or redemption of ETF tokens. The remote server continuously updates an exchange value between the plurality of cryptocurrency types and the ETF token type (Step E). The exchange value is the net asset value of the ETF token type which varies based on the market values of the cryptocurrencies and the status of the stock index or bond index which is tracked by the ETF token type. Thus, step E allows the exchange value to be tracked in real-time. The user PC device prompts the user account to select either a creation transaction or a redemption transaction (Step F). The creation transaction allows a user to purchase ETF tokens by using different types of digital currency. The redemption transaction allows a user to redeem different types of digital currency for previously purchased ETF tokens. The remote server executes the creation transaction in order to deposit a specific token quantity for the ETF token type into the corresponding user wallet (Step G). Step G is processed if the creation transaction is selected by the user account. The specific token quantity is respectively defined by the present invention and the user account. Firstly, the present invention defines an amount of ETF tokens that can be purchased as a whole then the user can decide how many ETF tokens in accordance to the amount defined by the present invention. In further detail, step G transfers ETF tokens into the corresponding user wallet. Thus, step G is used to buy share in a specific ETF. Alternatively, the remote server executes the redemption transaction in order to deposit a specific cryptocurrency amount for each cryptocurrency type into the corresponding user wallet (Step H). Step H is processed if the redemption transaction is selected by the user account. The specific cryptocurrency amount is defined by the market values of each cryptocurrency type and the status of the stock index or bond index tracked by the ETF token type. Thus, step H is used to sell share specific ETF. In further detail, step H transfers digital currencies from the corresponding administrative wallet into the corresponding user wallet. Steps G and/or H is recorded and verified with the blockchain ledger (Step I). Step I prevents any modification to the details and history of transactions processed through the present invention.

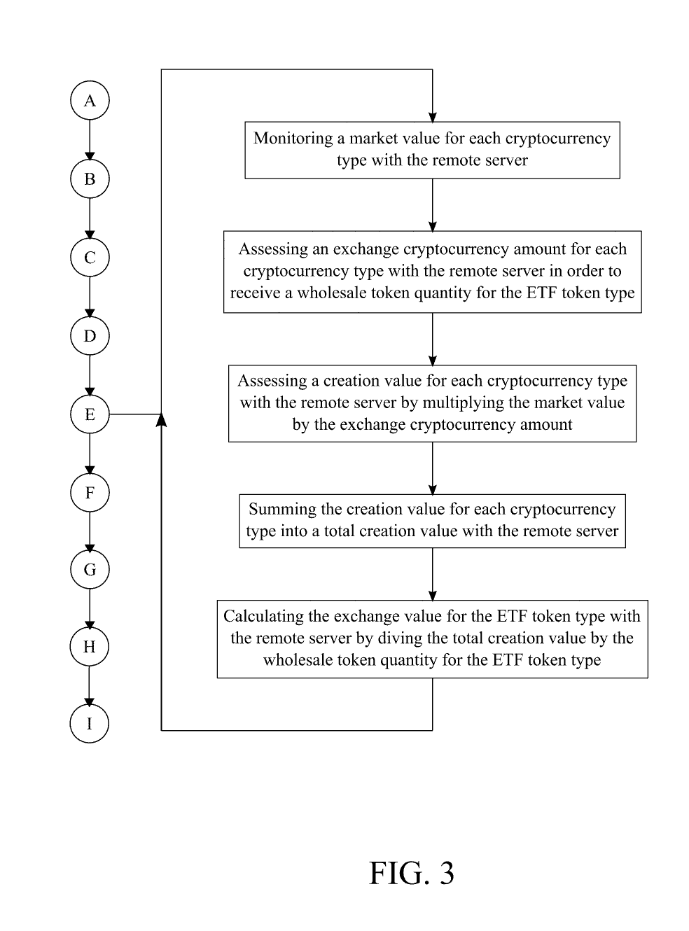

With reference to FIG. 3, the following subprocess is used to determine and continuously update the exchange value. The remote server monitors a market value for each cryptocurrency type. The market value is the monetary worth of each cryptocurrency type. This step can be processed by continuously retrieving the market value for each cryptocurrency type from the respective source of each cryptocurrency. For example, the market value for Bitcoin is retrieved from the blockchain of Bitcoin. The remote server assesses an exchange cryptocurrency amount for each cryptocurrency type in order to receive a wholesale token quantity for the ETF token type. The exchange cryptocurrency amount is a specific amount of each cryptocurrency type that is required in order to initiate the creation transaction for the ETF token type. The wholesale token quantity for the ETF token type is a specific amount of ETF token type defined by the administrator of the present invention. For example, the administrator can define the wholesale token quantity to be a thousand ETF tokens. The remote server then assesses a creation value for each cryptocurrency type by multiplying the market value by the exchange cryptocurrency amount. The creation value is value for the ETF token type in reference to each cryptocurrency type. The remote server sums the creation value for each cryptocurrency type into a total creation value. The total creation value is the total value for the ETF token if the digital currencies are exchanged for the ETF token type. The remote server finally calculates the exchange value for the ETF token type by diving the total creation value by the wholesale token quantity for the ETF token type.

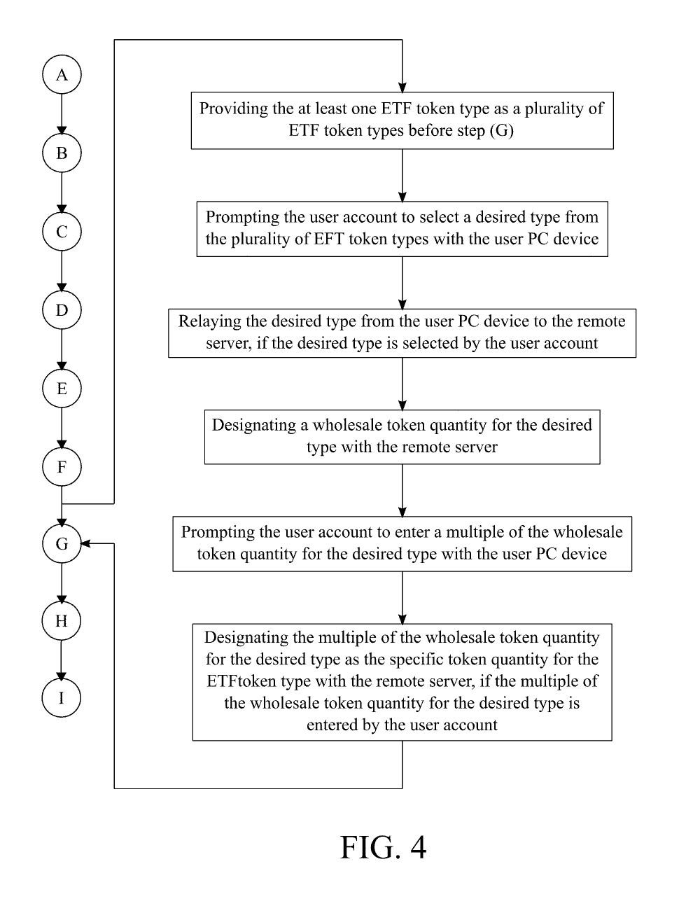

With reference to FIG. 4, the following subprocess is used to determine the specific token quantity, and, for this subprocess the at least one ETF token type is provided as a plurality of ETF token types before step G. The user PC device prompts the user account to select a desired type from the plurality of ETF token types. This step allows the user to select a specific token type based on the risk level of the ETF token type. The risk level is dependent on the stock index or bond index tracked by the ETF token type. The desired type is relayed from the user PC device to the remote server. This step is processed if the desired type is selected by the user account. The remote server designates the wholesale token quantity for the desired type. In further detail, the whole token quantity is defined by the administrator of the present invention. The user PC device then prompts the user account to enter a multiple of the wholesale token quantity for the desired type. This allows the user to purchase multiple of the wholesale quantity for the desired type. For example, if the wholesale quantity is a thousand ETF tokens, the user can choose to buy ETF tokens per thousand. The remote server designates the multiple of the wholesale token quantity for the desired type as the specific token quantity for the ETF token type. This step is processed if the multiple of the wholesale quantity for the desired type is entered by the user account.

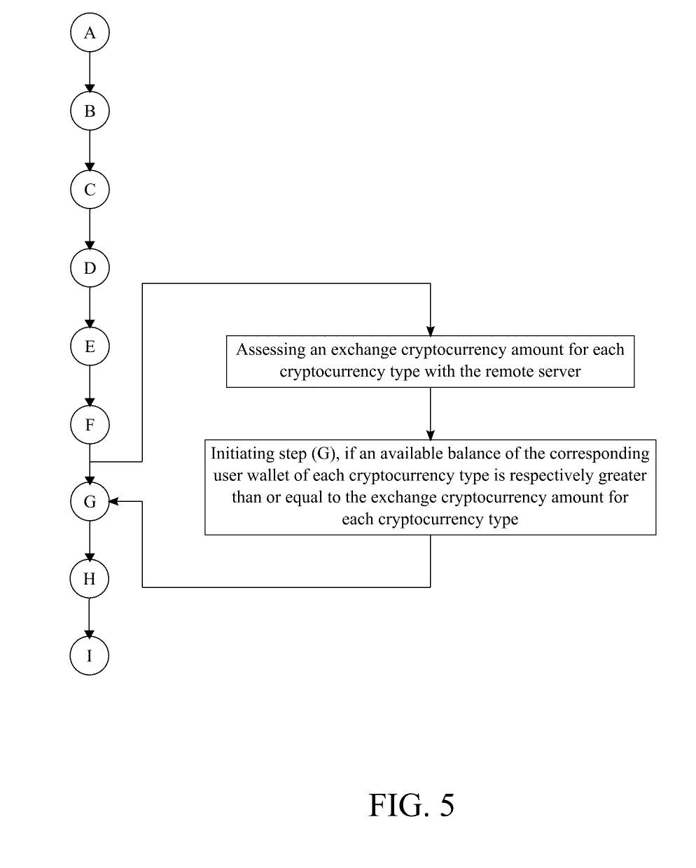

With reference to FIG. 5, the following subprocess is used to determine if the user has sufficient funds in order to initiate the creation transaction. Step G is initiated if an available balance of the corresponding user wallet of each cryptocurrency type is respectively greater than or equal to the exchange cryptocurrency amount for each cryptocurrency type. The available balance is the current balance of each cryptocurrency stored in the corresponding user wallet. If the available balance of the corresponding user wallet is less than the exchange cryptocurrency amount, then the user is not allowed to initiate the creation transaction.

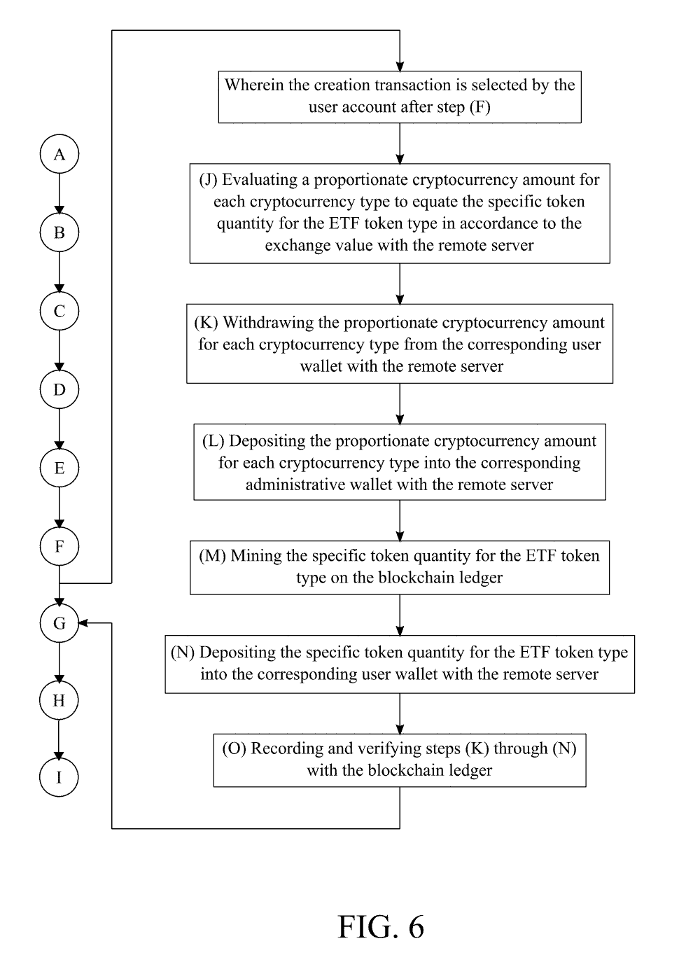

With reference to FIG. 6, the following subprocess is used to transfer ETF tokens into the corresponding user wallet, wherein the creation transaction is selected by the user account after step F. The remote server evaluates a proportionate cryptocurrency amount for each cryptocurrency type to equate the specific token quantity for the ETF token type in accordance to exchange value (Step J). The proportionate cryptocurrency amount for each cryptocurrency type is the specific amount needed to purchase the specific token quantity through the present invention. The remote server proceeds to withdraw the proportionate cryptocurrency amount for each cryptocurrency type from the corresponding user wallet (Step K). In further detail, step K removes the specific amount for each cryptocurrency type from the corresponding user wallet in order to receive the specific token quantity for the ETF token type. The remote server deposits the proportionate cryptocurrency amount for each cryptocurrency type into the corresponding administrative wallet (Step L). Step L notifies the administrator of the present invention that the user account has providing the necessary amount of each cryptocurrency type in order to receive the specific token quantity for the ETF token type. The specific token quantity for the ETF token type is mined on the blockchain ledger (Step M). Step M produces newly minted ETF tokens if the corresponding administrative wallet does not include a sufficient amount of ETF tokens for the ETF token type to transfer to the corresponding user wallet. Step M is processed according to a smart contract of the ETF token type. The smart contract is a self-executing digital contract that includes the terms of agreement between the user and the administrator of the present invention. Moreover, this step increases the mintage and the number of ETF tokens for the ETF token type in circulation. The remote server deposits the specific token quantity for the ETF token type into the corresponding user wallet (Step N). In further detail, the user is now in possession of ETF tokens in order to trade or exchange the ETF tokens on an exchange platform after step N. Steps K through N are recorded and verified with the blockchain ledger (Step O). Step O prevents any modification of the creation transaction.

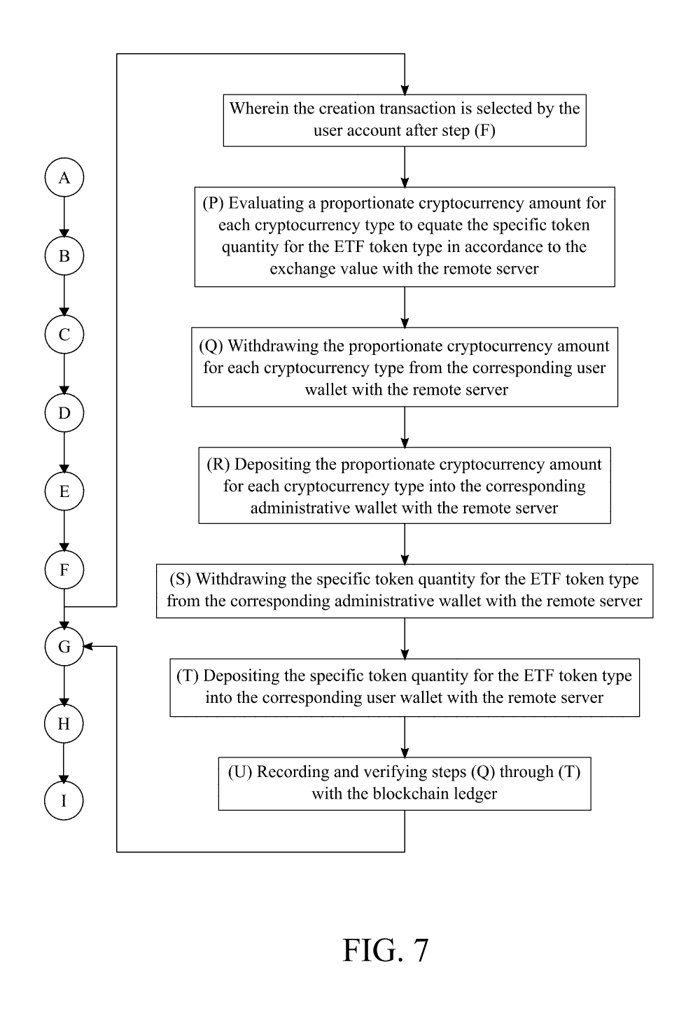

Alternatively and with reference to FIG. 7, the remote server evaluates a proportionate cryptocurrency amount for each cryptocurrency type to equate the specific token quantity for the ETF token type in accordance to exchange value (Step P). The proportionate cryptocurrency amount for each cryptocurrency type is the specific amount needed to purchase the specific token quantity through the present invention. The remote server proceeds to withdraw the proportionate cryptocurrency amount for each cryptocurrency type from the corresponding user wallet (Step Q). In further detail, step Q removes the specific amount for each cryptocurrency type from the corresponding user wallet in order to receive the specific token quantity for the ETF token type. The remote server deposits the proportionate cryptocurrency amount for each cryptocurrency type into the corresponding administrative wallet (Step R). Step R notifies the administrator of the present invention that the user account has providing the necessary amount of each cryptocurrency type in order to receive the specific token quantity for the ETF token type. The remote server withdraws the specific token quantity for the ETF token type from the corresponding administrative wallet (Step S). Step S is processed in accordance to a smart contract of the ETF token type and if the corresponding administrative wallet includes sufficient ETF tokens for the ETF token type. The remote server deposits the specific token quantity for the ETF token type into the corresponding user wallet (Step T). In further detail, the user is now in possession of ETF tokens in order to trade or exchange the ETF tokens on an exchange platform after step T. Steps Q through T are recorded and verified with the blockchain ledger (Step U). Step U prevents any modification of the creation transaction.

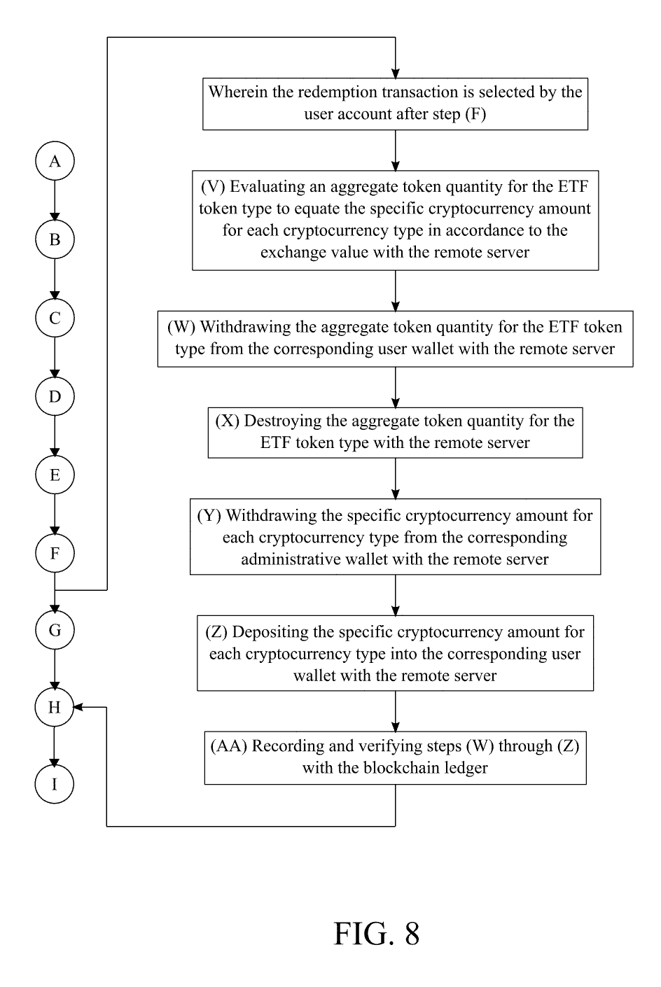

With reference to FIG. 8, the following subprocess is used to transfer digital currencies from the corresponding administrative wallet, into the corresponding user wallet wherein the redemption transaction is selected by the arbitrary account in step F. The remote server evaluates an aggregate token quantity for the ETF token type to equate the specific cryptocurrency amount for each cryptocurrency type in accordance to the exchange value (Step V). The aggregate token quantity is a specific amount of ETF tokens for the ETF token type which is needed to receive the specific cryptocurrency amount for each cryptocurrency type. The remote server withdraws the aggregate token quantity for ETF token type from the corresponding user wallet (Step W). In further detail, step W removes the aggregate token quantity for the ETF token type from the corresponding user wallet in order to receive the specific cryptocurrency amount for each cryptocurrency type. The remote server destroys the aggregate token quantity token for the ETF token type (Step X). Step X is processed in accordance to a smart contract for the ETF token type. The smart contract is a self-executing digital contract that includes the terms of agreement between the user and the administrator of the present invention. Moreover, step X reduces the mintage and the amount of ETF tokens for the ETF token type in circulation. The remote server withdraws the specific cryptocurrency amount for each cryptocurrency type from the corresponding administrative wallet (Step Y). Step Y prepares the digital currencies for the deposit process of the redemption transaction. The remote server deposits the specific cryptocurrency amount for each cryptocurrency type into the corresponding user wallet (Step Z). In further detail, step Z transfers the digital currencies into the possession of the user in order for the user to trade or exchange the digital currencies. Steps W through Z are recorded and verified with blockchain ledger (Step AA). Step AA prevents any medication to the redemption transaction.

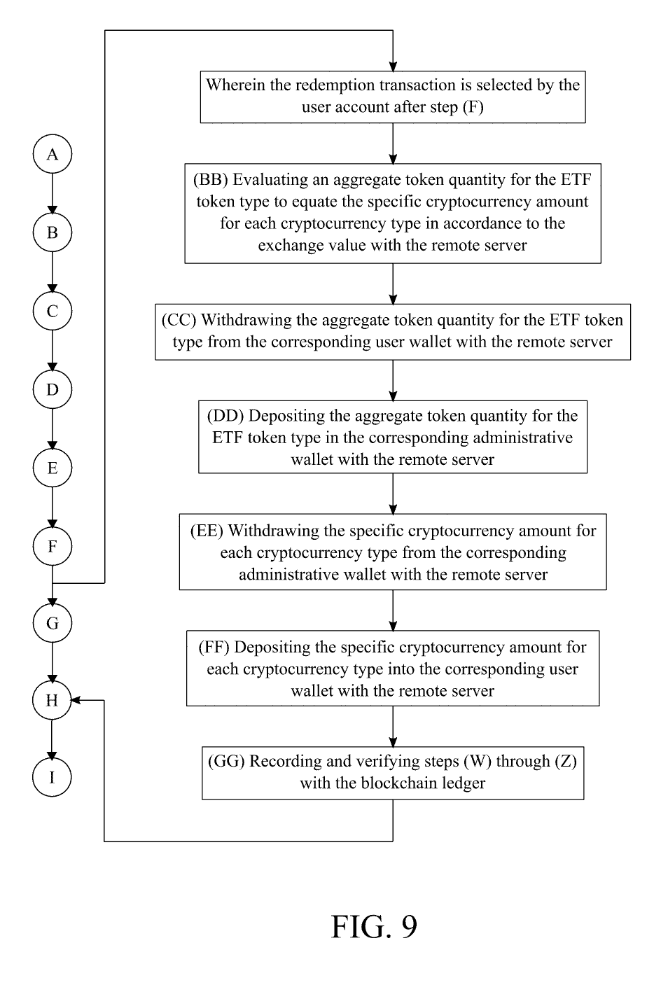

Alternatively and with reference to FIG. 9, the remote server evaluates an aggregate token quantity for the ETF token type to equate the specific cryptocurrency amount for each cryptocurrency type in accordance to the exchange value (Step BB). The aggregate token quantity is a specific amount of ETF tokens for the ETF token type which is needed to receive the specific cryptocurrency amount for each cryptocurrency type. The remote server withdraws the aggregate token quantity for ETF token type from the corresponding user wallet (Step CC). In further detail, step CC removes the aggregate token quantity for the ETF token type from the corresponding user wallet in order to receive the specific cryptocurrency amount for each cryptocurrency type. The remote server deposits the aggregate token quantity for the ETF token type in the corresponding administrative wallet (Step DD). Step DD is processed in accordance to a smart contract for the ETF token type. Moreover, step DD does not reduce the mintage and the amount of ETF tokens for the ETF token type in circulation. The remote server withdraws the specific cryptocurrency amount for each cryptocurrency type from the corresponding administrative wallet (Step EE). Step EE prepares the digital currencies for the deposit process of the redemption transaction. The remote server deposits the specific cryptocurrency amount for each cryptocurrency type into the corresponding user wallet (Step FF). In further detail, step FF transfers the digital currencies into the possession of the user in order for the user to trade or exchange the digital currencies. Steps BB through FF are recorded and verified with blockchain ledger (Step GG). Step GG prevents any medication to the redemption transaction.

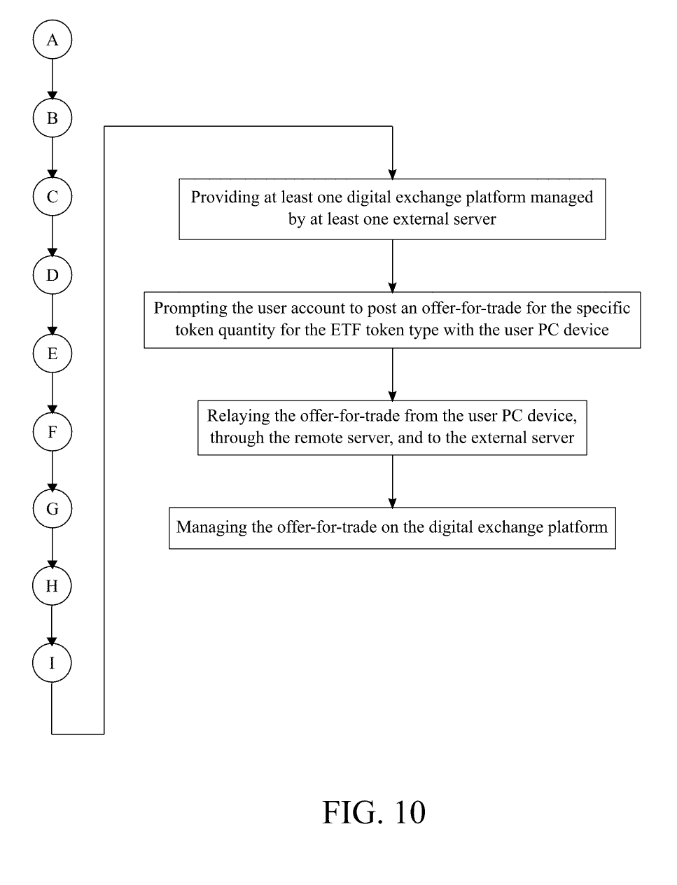

With reference to FIG. 10, the following subprocess allows the user to trade the ETF token type on an exchange platform. At least one external server is used to manage at least one digital exchange platform. The external sever is a centralized server which manages the administrative and user processes of the digital exchange platform. The digital exchange platform allows users to trade or exchange different types of digital currencies. The user PC device prompts the user account to post an offer-for-trade for the specific token quantity for the ETF token type. The offer-for-trade allows public users of the digital exchange platform to purchase and/or sell ETF tokens for the ETF token type. The offer-for-trade is relayed from the user PC device, through the remote server, and to the external server. The offer-for-trade is managed on the digital exchange platform.

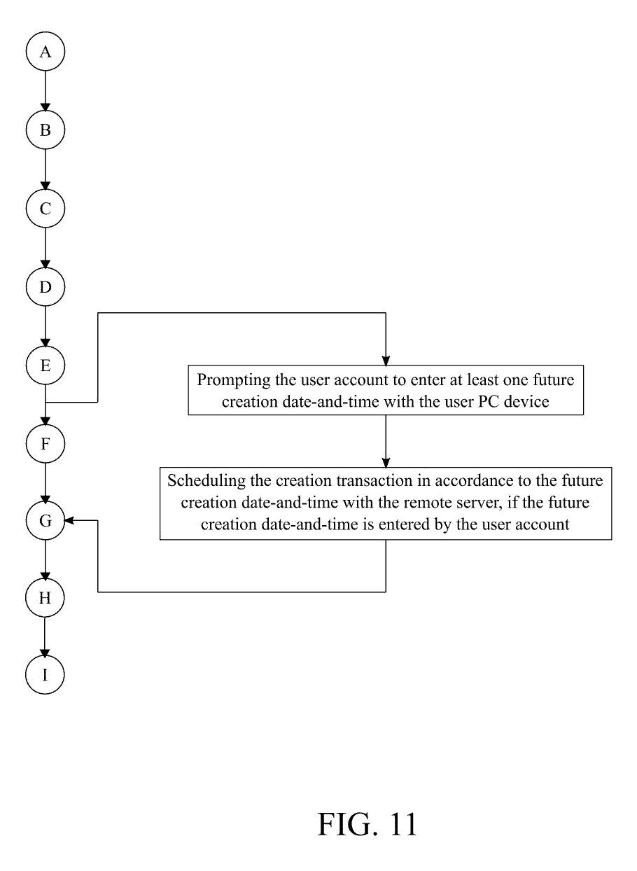

With reference to FIG. 11, the following subprocess allows a user to schedule a future creation transaction. The user PC device prompts the user account to enter at least one future creation date-and-time. The at least one future creation date-and-time may be any day or time that is desired for the user. Furthermore, the user instructs the present invention to initiate the creation transaction without actively using the present invention at the time of the creation transaction at the future creation date-and-time. The remote server schedules the creation transaction in accordance to the future creation date-and-time. This step is processed if the future creation date-and-time is entered by the user account. Moreover, this step ensures that the creation transaction is processed at the future creation date-and-time.

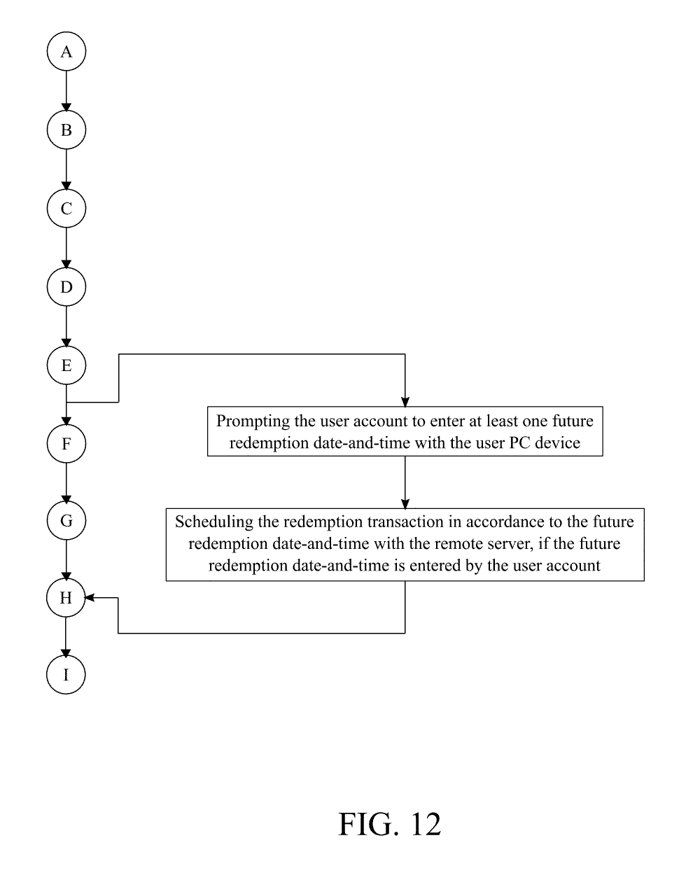

Similarly and with reference to FIG. 12, the following subprocess allows a user to schedule a future redemption transaction. The user PC device prompts the user account to enter at least one future redemption date-and-time. The at least one future redemption date-and-time may be any day or time that is desired for the user. Furthermore, the user instructs the present invention to initiate the redemption transaction without actively using the present invention at the time of the redemption transaction at the future creation date-and-time. The remote server schedules the redemption transaction in accordance to the future redemption date-and-time. This step is processed if the future redemption date-and-time is entered by the user account. Moreover, this step ensures that the redemption transaction is processed at the future creation date-and-time.

### Supplemental Description

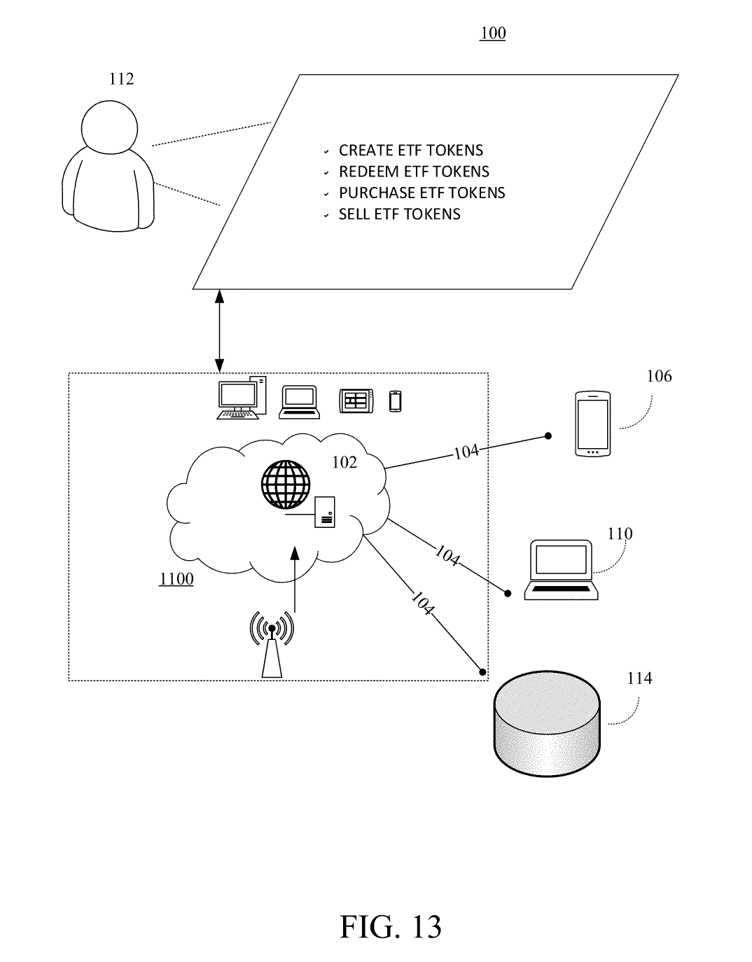

FIG. 13 is an illustration of an online platform 100 consistent with various embodiments of the present disclosure. By way of non-limiting example, the online platform 100 to facilitate the creation and/or redemption of ETF tokens representing a portfolio of multiple cryptocurrencies may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 100 (such as desktop computers, server computers etc.) and databases 104 over a communication network 104, such as, but not limited to, the Internet. Further, users of the online platform 100 may include relevant parties such as, but not limited to, traders, business persons, investors, fund managers, administrators, regulators and so on. Accordingly, in some instances, electronic devices operated by the one or more relevant parties may be in communication with the platform.

A user 102, such as the one or more relevant parties, may access online platform 100 through a web-based software application or browser. The web-based software application may be embodied as, for example, but not be limited to, a website, a web application, a desktop application, and a mobile application compatible with a computing device 800.

According to some embodiments, the online platform 100 may be configured to facilitate the creation and/or redemption of ETF tokens representing a portfolio of multiple cryptocurrencies. The portfolio/basket of multiple cryptocurrencies may include a plurality of cryptocurrencies of one or more quantities. Accordingly, the plurality of cryptocurrencies may be stored on multiple associated wallets, which in some embodiments, may be configured to be in communication with the online platform. Further, the plurality of cryptocurrencies may be associated with unique wallet addresses.

Further, the online platform 100 may communicate with one or more user devices. The one or more user devices may include one or more mobile devices such as, but not limited to, smartphones, computer tablets, laptops, and so on. The one or more user devices may include a communication device configured to communicate over a communication network such as, but not limited to, a cellular network, a satellite network, a personal area network, Bluetooth, Internet and so on. The one or more users of the online platform 100, such as inventors, business persons, and so on, may use the one or more user devices to access the online platform 100 to perform creation and/or redemption of ETF tokens.

The online platform 100 may receive one or more ETF token creation requests from one or more user devices, which may include information about the ETF. For instance, the ETF creation requests may include information such as details about a plurality of cryptocurrencies in the portfolio of the ETF, and respective percentages of the plurality of cryptocurrencies in the portfolio of the ETF. Further, the ETF creation requests may include information about a number of one or more ETF tokens that may need to be created for the ETF. For instance, 1000 ETF tokens may need to be created for the ETF. Accordingly, the number of ETF tokens may decide a net asset value of the ETF tokens. The total value of the ETF may be divided by the number of the ETF tokens to represent the value of individual ETF tokens. Further, the ETF creation requests may include details about one or more wallets, such as one or more wallet addresses, where one or more tokens of the plurality of cryptocurrencies may be stored. Accordingly, the online platform 100 may retrieve one or more cryptocurrency tokens from the one or more respective wallets and generate one or more ETF tokens. Alternatively, in some embodiments, the one or more ETF tokens may be drawn from a pre-existing ETF token pool. The one or more ETF tokens may be transferred to one or more designated wallets of the one or more users.

Further, the online platform 100 may receive one or more ETF redemption requests from one or more users. The ETF redemption requests may include information about one or more ETFs. For instance, an ETF redemption request may include information such as details about the plurality of cryptocurrencies in the portfolio of the ETF, and percentage of the plurality of cryptocurrencies in the portfolio of the ETF. Alternatively, the ETF redemption request may specify a unique code or key corresponding to an ETF and/or the one or more ETF tokens associated with the ETF. Accordingly, based on the ETF redemption request, one or more ETF tokens may be received from the one or more users, and one or more corresponding cryptocurrency tokens may be transferred to one or more designated wallets of the one or more users. Subsequently, the one or more ETF tokens may be destroyed according to the blockchain based Smart Contract. Alternatively, the one or more ETF tokens may be returned to the pre-existing ETF token pool.

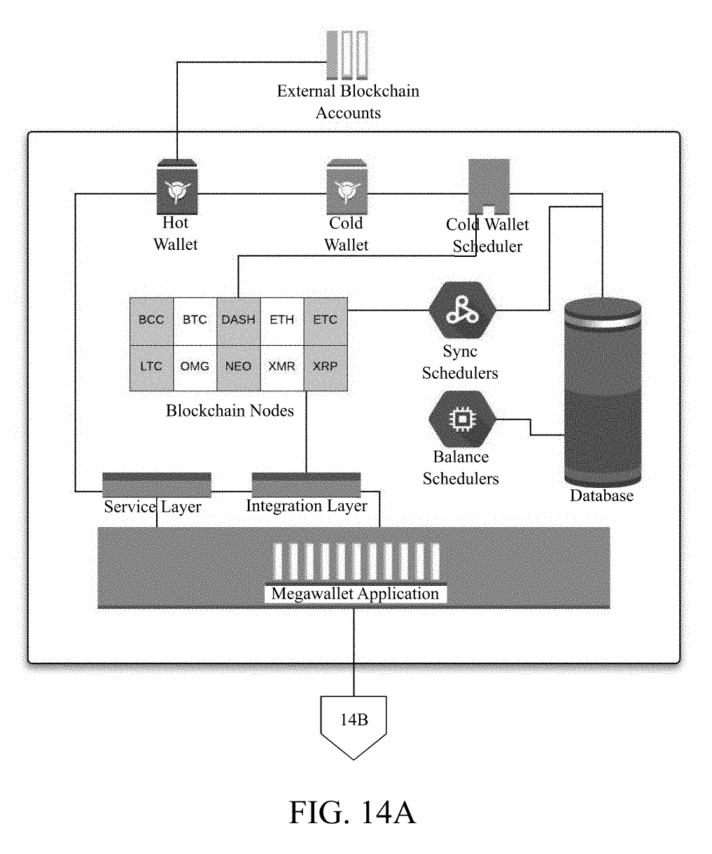

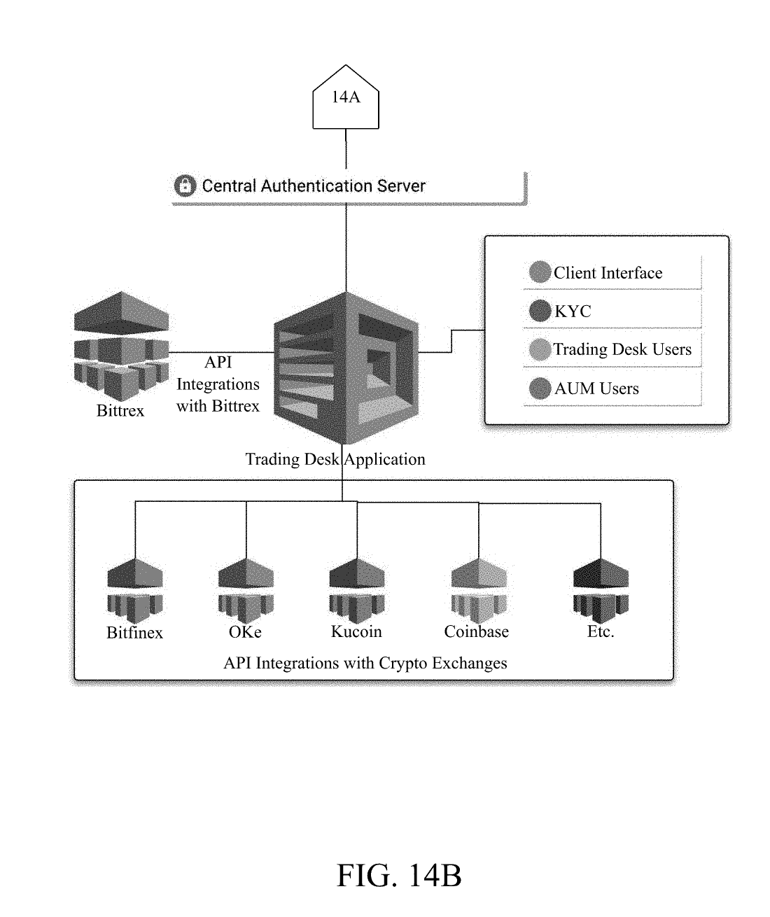

FIGS. 14A and 14B show an exemplary architecture of the system to facilitate the creation and/or redemption of ETF tokens, representing a portfolio of multiple cryptocurrencies. The system may facilitate the exchange trading process of an ETF within the context of cryptocurrencies with settlement on a blockchain. Any blockchain that may utilize Smart Contracts and may issue a token may be utilized. such as Ethereum or Waves. Further, the system may assemble a ‘Creation Unit’ of cryptocurrencies that may be comprised of any number of cryptocurrencies, in any quantity and with any market value. The Creation Unit may be alternatively called as ‘basket’. Each cryptocurrency may have a value expressed in USD/BTC/ETH and a sum of those values divided by a number of ETF tokens will discover NAV or (net asset value) of each ETF token. Each cryptocurrency in the Creation Unit may have a wallet addresses (which may be a sequence of 0-40 random characters). Further, the system may control the movement of cryptocurrency tokens in and out of individual wallets, for instance through blockchain nodes, in unison as a Creation Unit or basket. Accordingly, the system may include a wallet, called as megawallet that may aggregate cryptocurrencies from each cryptocurrency wallet and may control the movement of the coins together as a unit. Further, the present invention may facilitate creation and/or redemption. The process of creation may involve qualifying that each wallet may have enough respective cryptocurrencies to satisfy the requirements of the Creation Unit. Then the present invention may withdraw all the cryptocurrencies, and transfer the cryptocurrencies to an inaccessible wallet(s) as a Creation Unit, with each Creation Unit containing underlying cryptocurrencies required to initiate creation. The inaccessible cryptocurrencies may be called as asset under management (AUM). Further, the present invention may initiate minting of new ETF tokens, or transfer of ETF tokens according to the Smart Contract of the blockchain. These ETF tokens may be given in exchange for the one or more cryptocurrencies in the present invention.

Further, redemption may be initiated by a user and ETF tokens may be withdrawn from the user wallet. The ETF tokens may be destroyed or deposited into the AUM wallet(s). The one or more Creation Unit cryptocurrencies, along with one or more underlying cryptocurrencies, may be withdrawn from the AUM wallets and may be then deposited into the wallet of the user. The redeemed ETF tokens may be either returned to the AUM or destroyed according to the Smart Contract of the blockchain. The underlying currencies may be returned in exchange.

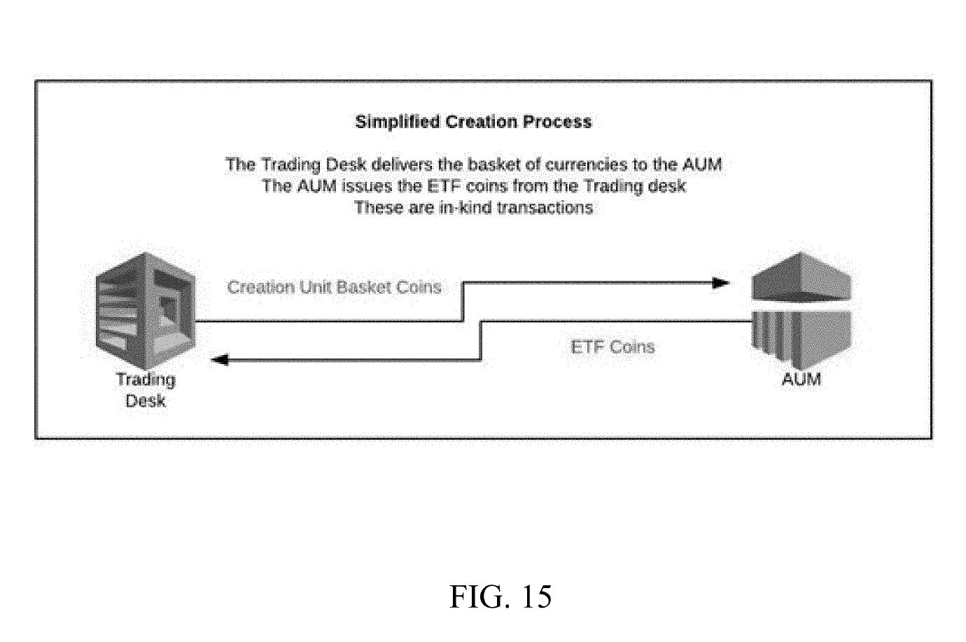

FIG. 15 shows a process to facilitate the ‘creation’ of ETF tokens representing a portfolio of multiple cryptocurrencies, in accordance with some embodiments. An ETF token creation request may be received at a trading desk. The creation request may include information about the ETF, that may represent an index, or value of one or more cryptocurrencies, or the number of one or more cryptocurrency tokens that may be present in the Creation Unit or basket of the ETF. For instance, the ETF token creation request may include information such as details about the one or more cryptocurrencies in the Creation Unit, and percentage weight, the quantity of one or more cryptocurrencies, the market value of the one or more cryptocurrencies in the Creation Unit. The Creation Unit, which may include the one or more cryptocurrencies in the described amount, may be stored, using blockchain technology, in a wallet. The retrieved cryptocurrencies may be kept in an inaccessible wallet as a secure asset against which the ETF, and the one or more ETF tokens may be considered asset backed. In an instance, the retrieved cryptocurrency tokens may be stored and may be designated as assets under management. As such, the inaccessible wallet may be called as AUM wallet or assets under management wallet.

Further, the AUM wallet may mint one or more ETF tokens based on the ETF token creation request. The one or more ETF tokens may be minted on the basis of the information in the ETF token creation request. For instance, the value of the one or more ETF tokens may be decided by the number and percentage of one or more cryptocurrencies that may constitute the Creation Unit. Further, the number of ETF tokens, that may need to be generated as per the ETF token creation request may describe the net asset value or individual value of the generated ETF tokens. Further, the generated ETF tokens may each be unique and may be represented by unique codes or keys, such as alphanumeric codes. Further, the generated ETF tokens may be transferred to the trading desk of the Authorized Participant, and then to a designated wallet, whereupon, the one or more ETF tokens may be traded, bought, sold, or transferred to other wallets. The designated wallet may be a mobile digital wallet. Alternatively, the designated wallet may be a hardware wallet that may store the unique codes or keys, such as alphanumeric codes, related to the received ETF tokens.

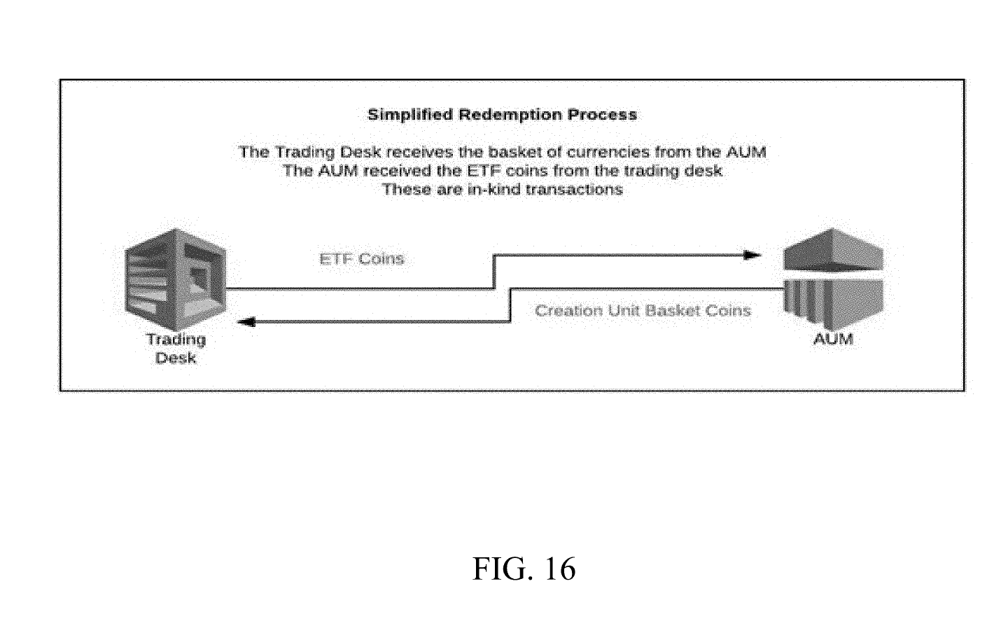

FIG. 16 shows a process to facilitate the ‘redemption’ of ETF tokens representing a portfolio of multiple cryptocurrencies, in accordance with some embodiments. An ETF token redemption request may be received at a trading desk of the Authorized Participant of the system from a user device. The ETF token redemption request may include information about an ETF token, which may represent an index or value of one or more cryptocurrencies that may be present in the basket of the ETF and may comprise of the portfolio of the ETF. For instance, the ETF token redemption request may include information such as details about the one or more cryptocurrencies in the portfolio of the ETF, the percentage weight of the one or more currencies in the portfolio of the ETF represented by the number of tokens and the market value of the one or more cryptocurrencies. For instance, the ETF may draw value from one or more cryptocurrencies such as Bitcoin®, Ethereum®, Bitcoin Cash®, and Ripple®. Further, the ETF token redemption request may specify a unique code or key of the one or more ETF tokens that may need to be redeemed. Further, the required amount of one or more ETF tokens may be retrieved from one or more associated wallets and stored, blockchain technology, in an inaccessible wallet of the Issuer. The retrieved ETF tokens may be stored and may be designated as assets under management. As such, the inaccessible wallet may be called the AUM wallet or assets under management wallet. Further, one or more Creation Units, including one or more associated cryptocurrencies, may be transmitted to the trading desk. The one or more Creation Units may represent the value of the one or more ETF tokens as present in the ETF token redemption request. Further, the one or more Creation Units, and underlying cryptocurrencies may be transferred to a designated wallet, whereupon, the one or more associated cryptocurrencies may be traded, bought, sold, or transferred to other wallets.

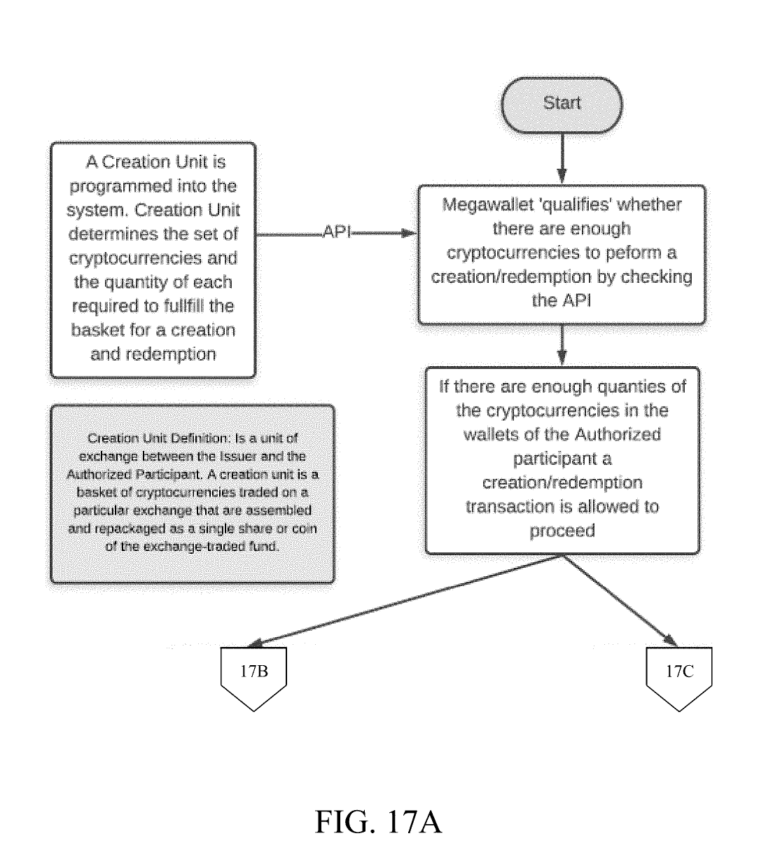

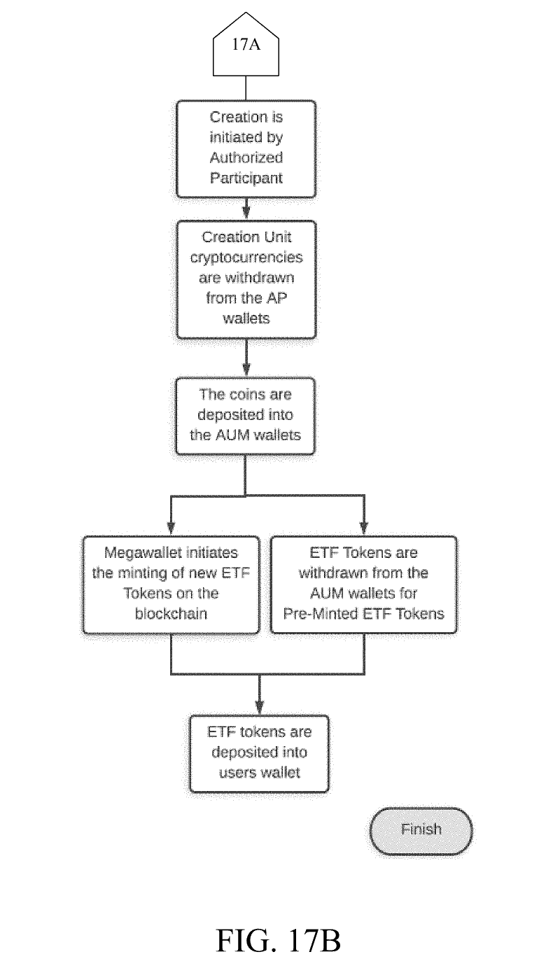

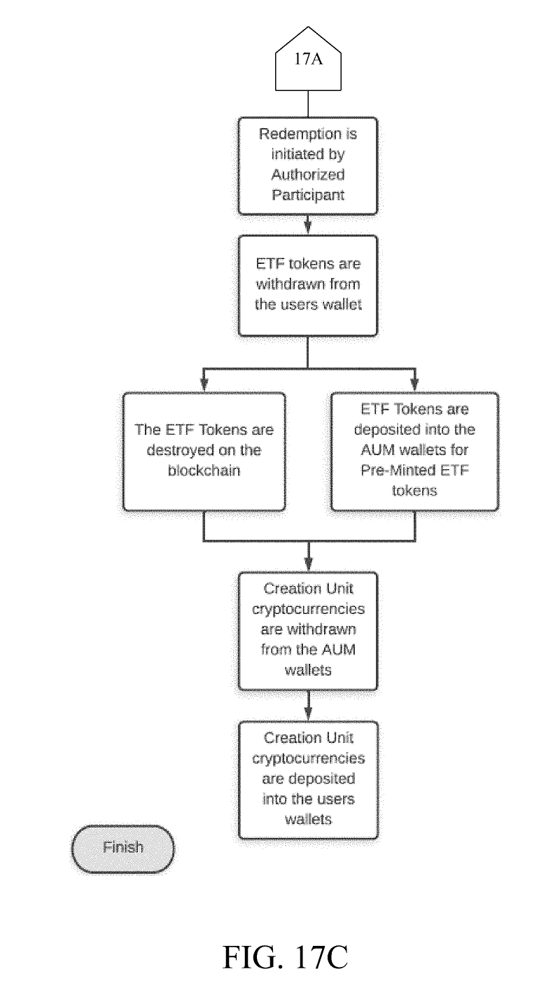

FIGS. 17A, 17B, and 17C show an exemplary flowchart displaying the processes of creation and/or redemption, in accordance with some embodiments.

In creation, a Creation Unit may be programmed into the system. The creation request may include indication of a plurality of cryptocurrencies and a corresponding plurality of quantities associated with the plurality of cryptocurrencies. The plurality of cryptocurrencies and a corresponding plurality of quantities associated with the plurality of cryptocurrencies may comprise the Creation Unit. Further, the Creation Unit may be a set of coins underlying an exchange traded fund. The Creation Unit may be a basket of cryptocurrencies traded on a particular exchange that may be assembled and repackaged as a single share or coin of the exchange-traded fund. The Creation Unit may determine the set of cryptocurrencies and quantity of each cryptocurrency required to fulfill the basket. Further, the creation request may also include a number of shares (or ETF tokens). A combination of the plurality of cryptocurrencies according to the plurality of quantities may constitute a basket. Accordingly, the Creation Unit may be partitioned into the number of shares resulting in a one or more ETF tokens which may be subsequently traded. Further, the specialized wallet, called as a “megawallet” may qualify whether there may be enough cryptocurrencies in one or more respective wallets to perform a creation/redemption by checking the balances of respective wallets. The present invention may determine whether each wallet of the plurality of wallets includes an amount of cryptocurrency sufficient to perform the creation/redemption. In particular, the present invention may verify whether the plurality of quantities specified in the Creation Unit is satisfied by a plurality of amounts of cryptocurrencies currently available in the plurality of wallets. If enough cryptocurrencies are present in the wallets to satisfy the set of cryptocurrencies needed for the Creation Unit, creation/redemption process may be allowed to proceed. Creation may be initiated by a user and Creation Unit coins may be withdrawn from respective wallets. The coins may be deposited into one or more inaccessible wallets, called as AUM (assets under management) wallets. ETF tokens may be mined, and newly minted or existing ETF tokens may be withdrawn from the AUM wallet. ETF tokens may then be deposited into a designated wallet of the user. Further, the process of redemption may be initiated by the user. A corresponding redemption request may be received from a user device of the user. Accordingly, the “megawallet” may be analyzed to determine whether the “megawallet” may include one or more amounts of cryptocurrencies sufficient to satisfy the redemption request. In particular, the plurality of amounts of cryptocurrencies corresponding to one or more ETF tokens associated with the redemption request may be verified to be currently available in the “megawallet”. Accordingly, one or more ETF tokens may be withdrawn from the “megawallet” of the user to obtain the plurality of cryptocurrencies. The ETF tokens may be then destroyed on the blockchain or deposited into the AUM wallets. Corresponding Creation Unit cryptocurrencies with values equal to the values of the retrieved ETF tokens may be withdrawn from the AUM wallets and deposited into the wallet of the Authorized Participant.

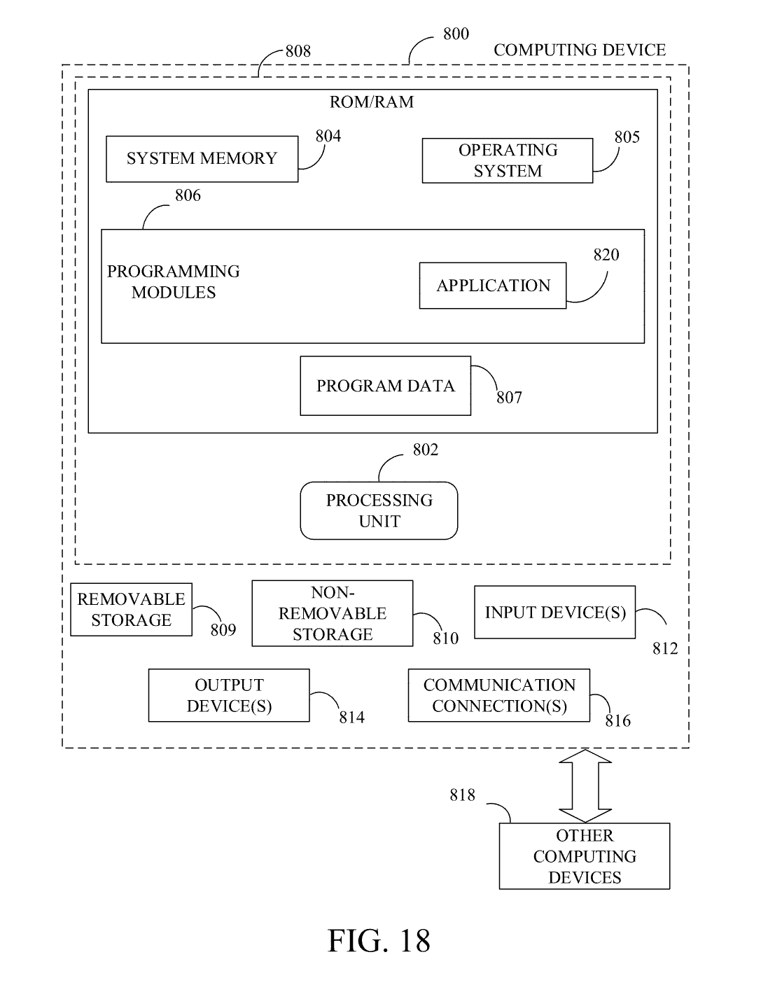

With reference to FIG. 18, a system consistent with an embodiment of the disclosure may include a computing device or cloud service, such as computing device 800. In a basic configuration, computing device 800 may include at least one processing unit 802 and a system memory 804. Depending on the configuration and type of computing device, system memory 804 may comprise, but is not limited to, volatile (e.g. random-access memory (RAM)), non-volatile (e.g. read-only memory (ROM)), flash memory, or any combination. System memory 804 may include operating system 805, one or more programming modules 806, and may include a program data 807. Operating system 805, for example, may be suitable for controlling computing device 800's operation. In one embodiment, programming modules 806 may include a machine learning module and/or data processing module. Furthermore, embodiments of the disclosure may be practiced in conjunction with a graphics library, other operating systems, or any other application program and is not limited to any particular application or system. This basic configuration is illustrated in FIG. 18 by those components within a dashed line 808.

Computing device 800 may have additional features or functionality. For example, computing device 800 may also include additional data storage devices (removable and/or non-removable) such as, for example, magnetic disks, optical disks, or tape. Such additional storage is illustrated in FIG. 18 by a removable storage 809 and a non-removable storage 810. Computer storage media may include volatile and nonvolatile, removable and non-removable media implemented in any method or technology for storage of information, such as computer-readable instructions, data structures, program modules, or other data. System memory 804, removable storage 809, and non-removable storage 810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a touch input device, a location sensor, a camera, a biometric sensor, etc. Output device(s) 814 such as a display, speakers, a printer, etc. may also be included. The aforementioned devices are examples and others may be used.

Computing device 800 may also contain a communication connection 816 that may allow device 800 to communicate with other computing devices 818, such as over a network in a distributed computing environment, for example, an intranet or the Internet. Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 804, including operating system 805. While executing on processing unit 802, programming modules 806 (e.g., application 820 such as a media player) may perform processes including, for example, one or more stages of methods, algorithms, systems, applications, servers, databases as described above. The aforementioned process is an example, and processing unit 802 may perform other processes. Other programming modules that may be used in accordance with embodiments of the present disclosure may include data decoding applications, machine learning application etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention as hereinafter claimed.

What is claimed is:

1. A method of managing a cryptocurrency-based portfolio, the method comprises the steps of:
(A) providing a plurality of cryptocurrency types and at least one exchange trade fund (ETF) token type managed by at least one remote server;
(B) providing at least one user account managed by the remote server, wherein the user account is associated with a user personal computing (PC) device, and wherein the user account includes a plurality of user wallets, and wherein each cryptocurrency type or ETF token type is associated to a corresponding user wallet from the plurality of user wallets;
(C) providing a plurality of administrative wallets managed by the remote server, wherein each cryptocurrency type or ETF token type is associated to a corresponding administrative wallet from the plurality of administrative wallets;
(D) providing a blockchain ledger managed by a network of computing nodes;
(E) continuously updating an exchange value between the plurality of cryptocurrency types and the ETF token type with the remote server;
(F) prompting the user account to select either a creation transaction or a redemption transaction with the user PC device;
(G) executing the creation transaction with the remote server in order to deposit a specific token quantity for the ETF token type into the corresponding user wallet, if the creation transaction is selected by the user account;
(H) executing the redemption transaction with the remote server in order to deposit a specific cryptocurrency amount for each cryptocurrency type into the corresponding user wallet, if the redemption transaction is selected by the user account; and
(I) recording and verifying steps (G) and/or (H) with the blockchain ledger.

2. The method of managing a cryptocurrency-based portfolio, the method as claimed in claim 1 comprises the steps of:
monitoring a market value for each cryptocurrency type with the remote server;
assessing an exchange cryptocurrency amount for each cryptocurrency type with the remote server in order to receive a wholesale token quantity for the ETF token type;
assessing a creation value for each cryptocurrency type with the remote server by multiplying the market value by the exchange cryptocurrency amount;
summing the creation value for each cryptocurrency type into a total creation value with the remote server; and
calculating the exchange value for the ETF token type with the remote server by diving the total creation value by the wholesale token quantity for the ETF token type.

3. The method of managing a cryptocurrency-based portfolio, the method as claimed in claim 1 comprises the steps of:
providing the at least one ETF token type as a plurality of ETF token types before step (G);
prompting the user account to select a desired type from the plurality of EFT token types with the user PC device;
relaying the desired type from the user PC device to the remote server, if the desired type is selected by the user account;
designating a wholesale token quantity for the desired type with the remote server;
prompting the user account to enter a multiple of the wholesale token quantity for the desired type with the user PC device; and
designating the multiple of the wholesale token quantity for the desired type as the specific token quantity for the ETF token type with the remote server, if the multiple of the wholesale token quantity for the desired type is entered by the user account.

4. The method of managing a cryptocurrency-based portfolio, the method as claimed in claim 1 comprises the steps of:
assessing an exchange cryptocurrency amount for each cryptocurrency type with the remote server; and
initiating step (G), if an available balance of the corresponding user wallet of each cryptocurrency type is respectively greater than or equal to the exchange cryptocurrency amount for each cryptocurrency type.

5. The method of managing a cryptocurrency-based portfolio, the method as claimed in claim 1 comprises the steps of:
wherein the creation transaction is selected by the user account after step (F);
(J) evaluating a proportionate cryptocurrency amount for each cryptocurrency type to equate the specific token quantity for the ETF token type in accordance to the exchange value with the remote server;
(K) withdrawing the proportionate cryptocurrency amount for each cryptocurrency type from the corresponding user wallet with the remote server;
(L) depositing the proportionate cryptocurrency amount for each cryptocurrency type into the corresponding administrative wallet with the remote server;
(M) mining the specific token quantity for the ETF token type on the blockchain ledger;
(N) depositing the specific token quantity for the ETF token type into the corresponding user wallet with the remote server; and
(O) recording and verifying steps (K) through (N) with the blockchain ledger.

6. The method of managing a cryptocurrency-based portfolio, the method as claimed in claim 1 comprises the steps of:
wherein the creation transaction is selected by the user account after step (F);
(P) evaluating a proportionate cryptocurrency amount for each cryptocurrency type to equate the specific token quantity for the ETF token type in accordance to the exchange value with the remote server;
(Q) withdrawing the proportionate cryptocurrency amount for each cryptocurrency type from the corresponding user wallet with the remote server;
(R) depositing the proportionate cryptocurrency amount for each cryptocurrency type into the corresponding administrative wallet with the remote server;
(S) withdrawing the specific token quantity for the ETF token type from the corresponding administrative wallet with the remote server;
(T) depositing the specific token quantity for the ETF token type into the corresponding user wallet with the remote server; and
(U) recording and verifying steps (Q) through (T) with the blockchain ledger.

7. The method of managing a cryptocurrency-based portfolio, the method as claimed in claim 1 comprises the steps of:
wherein the redemption transaction is selected by the arbitrary account in step (F);
(V) evaluating an aggregate token quantity for the ETF token type to equate the specific cryptocurrency amount for each cryptocurrency type in accordance to the exchange value with the remote server;
(W) withdrawing the aggregate token quantity for the ETF token type from the corresponding user wallet with the remote server;
(X) destroying the aggregate token quantity for the ETF token type with the remote server;
(Y) withdrawing the specific cryptocurrency amount for each cryptocurrency type from the corresponding administrative wallet with the remote server;
(Z) depositing the specific cryptocurrency amount for each cryptocurrency type into the corresponding user wallet with the remote server; and
(AA) recording and verifying steps (W) through (Z) with the blockchain ledger.

8. The method of managing a cryptocurrency-based portfolio, the method as claimed in claim 1 comprises the steps of:
wherein the redemption transaction is selected by the arbitrary account in step (F);
(BB) evaluating an aggregate token quantity for the ETF token type to equate the specific cryptocurrency amount for each cryptocurrency type in accordance to the exchange value with the remote server;
(CC) withdrawing the aggregate token quantity for the ETF token type from the corresponding user wallet with the remote server;
(DD) depositing the aggregate token quantity for the ETF token type in the corresponding administrative wallet with the remote server;
(EE) withdrawing the specific cryptocurrency amount for each cryptocurrency type from the corresponding administrative wallet with the remote server;
(FF) depositing the specific cryptocurrency amount for each cryptocurrency type into the corresponding user wallet with the remote server; and
(GG) recording and verifying steps (BB) through (FF) with the blockchain ledger.

9. The method of managing a cryptocurrency-based portfolio, the method as claimed in claim 1 comprises the steps of:
providing at least one digital exchange platform managed by at least one external server;
prompting the user account to post an offer-for-trade for the specific token quantity for the ETF token type with the user PC device;
relaying the offer-for-trade from the user PC device, through the remote server, and to the external server; and
managing the offer-for-trade on the digital exchange platform.

10. The method of managing a cryptocurrency-based portfolio, the method as claimed in claim 1 comprises the steps of:
prompting the user account to enter at least one future creation date-and-time with the user PC device; and
scheduling the creation transaction in accordance to the future creation date-and-time with the remote server, if the future creation date-and-time is entered by the user account.

11. The method of managing a cryptocurrency-based portfolio, the method as claimed in claim 1 comprises the steps of:
prompting the user account to enter at least one future redemption date-and-time with the user PC device; and
scheduling the redemption transaction in accordance to the future redemption date-and-time with the remote server, if the future redemption date-and-time is entered by the user account.
